(19) United States
(12) Patent Application Publication
(10) Pub. No.: US 2016/0292945 A1
(43) Pub. Date: Oct. 6, 2016

(54) URBAN LOGISTICS PLATFORM

(71) Applicant: ROBERTO PABLO WALLER, PILAR, AR (US)

(72) Inventor: ROBERTO PABLO WALLER, PILAR, AR (US)

(21) Appl. No.: 14/217,346

(22) Filed: Mar. 17, 2014

(51) Int. Cl. G07C 9/00; G06Q 20/14; A47G 29/14

(52) U.S. Cl. CPC G07C 9/00912; A47G 29/141; G06Q 20/145; G07C 9/00571; G07C 9/00166; G07C 9/00944; A47G 2029/149; G07C 2009/00642

(57) ABSTRACT

A platform for urban logistics that can be used by the general public, individuals, and/or companies, to receive, send, store, share and/or exchange items.

The novel platform results from a combination of a distributed discrete network of public and/or private lockable cabinet arrays. Each array may contain a plurality of individual cabinets that may be of different sizes and that are equipped with plurality of accessing and security means. A local computer control unit, having management software, enables a plurality of functions, including transaction management and auditing, and it is connected to other arrays and users via the Internet.

### CROSS REFERENCE TO RELATED APPLICATIONS

This application claims priority to U.S. Provisional Application 61/786,621, titled Urban Logistics Public Platform, filed on Mar. 15, 2013, the entire contents of which are herein incorporated by reference.

### FEDERALLY SPONSORED RESEARCH

Not Applicable

### SEQUENCE LISTING OR PROGRAM

Not Applicable

### REFERENCES CITED

CA 2299671 A1 (Bhaskara Shyamsundar)

EP 1456794 B1 (Amy Sue Park, et al)

U.S. Ser. No. 13/706,255 (Donald E. Irwin, et al)

### BACKGROUND OF INVENTION

### Field Of The Invention

The invention relates to a logistics distribution center and method that facilitates delivery, retrieval, storing, sharing, and exchanging of goods. The inventive logistics distribution center may be used by the general public, individuals, and/or companies. The invention more specifically utilizes an array of lockable cabinets that are interconnected, accessible, and controlled through a network to allow a user to store, share, send, retrieve, and exchange items in a safe, reliable, auditable, and convenient manner.

### BACKGROUND

A cabinet is basically a box-shaped piece of furniture with doors or drawers for storing miscellaneous items. A lockable cabinet is accessed through a door and it is made secured through a variety of means, such as mechanical locks that require a physical opening device, electro-mechanical locks that use a combination of physical and electrical access means, and digital locks that require a code to allow a user to gain access to a cabinet. A lockable cabinet provides a user with the ability to store items in a safe and reliable manner, but may also be used in a plurality of ways, such as to receive, share, send, store, and exchange the items deposited within.

A conventional lockable cabinet can be accessed by any person who has possession of its physical key, or its electro-mechanical/digital access code. Conventional lockable cabinets lack auditing means to enable identification of every single operation conducted through the cabinet.

Existing commercial services cabinets, such as those provided by the United States Postal Service, Swapbox™, Bufferbox™, and Amazon Locker™, function as destination points for the reception of items. These services do not provide for exchange, sharing, or sending of items. Furthermore, traceability and auditing of cabinet's access is not contemplated in existing cabinets.

Fixed location cabinets, such as those provided by the US Postal Service and other commercial operators, provide a fixed location, fixed size cabinet, to receive items. Sharing and exchanging is limited to those with access to a physical key or access code. The current invention permits a user to use any number of cabinets in any place and of any size according to user need. This advantage provides the flexibility of dynamic allocation of cabinet resources.

Existing variable location cabinets, while allowing a user to choose its location, do not permit the determination of cabinet size, for which an intermediary is required. Furthermore, the utilization of these cabinets is a single operation that is used strictly to receive items, not to share, store, send, or exchange them.

Existing commercial lockable cabinet services allow users to select a receiving location, where they expect an item to be delivered. The receiving location normally may have an array of cabinets of various sizes, for which receiving personnel is used to help determine the most appropriate size to efficiently store the received item. The use of an intermediary, in addition to adding unnecessary costs, breaks the chain of title between the courier and the receiver, and it further adds a vulnerable point in safety procedure and custody, which the novel invention resolves.

Some of these commercially available reception services notify a user via e-mail and/or text message and provide an access code to the cabinet. The user then goes to the chosen cabinet location, enters the cabinet access code, and retrieves the stored item. This conventional access code permits multiple accesses to the lockable cabinet and that multiplicity defeats traceability of operation, which the novel invention remedies.

The present invention expands and augments in a novel way the functionality and capabilities of cabinet use by eliminating the need for personnel to make suitable cabinet allocations; it further provides additional services not contemplated by existing prior art, such that it enables cabinets to become a complete logistics center platform, not only for reception but for retrieval (sending), exchange, storing, and sharing of items placed within the cabinets.

### SUMMARY OF THE INVENTION

The present invention discloses a novel way to utilize multiple arrays of lockable cabinets, each containing a plurality of them in different sizes and located in a multiplicity of locations. The combination of distributed arrays of lockable cabinets constitutes a useful logistics platform, which enables users to operate any cabinet, of any size, at any location in the network, to store, share, exchange, send, and/or receive items from others.

A lockable cabinet within the novel platform is particularly useful not only as a destination address but also as an originating address, where commercial couriers, or authorized individuals, can retrieve an item deposited within the lockable cabinet.

Furthermore, the individual lockable cabinet may be used as an exchange point for items, thus permitting sharing and exchanging its contents. While these activities may seem the same, it is through its tracing and auditing functionality that they are distinguished.

Each single access to a specific cabinet is traced through a separate access code generated by the system. For example, the process of sending an item from a cabinet involves the step obtaining an access code to open the cabinet and placing an item therein, and the system generation and sending-off of a separate access code to the courier or person to retrieve the deposited item. While the process of sharing an item involves separate access codes not only for each sharing participant but also for each access by the same participant.

Additionally, each individual cabinet may be equipped with sensors and audiovisual equipment to detect, determine, and verify what was deposited or removed from a cabinet.

The novel invention is particularly useful because it is not dependent on intermediaries and works completely unattended. This is particularly useful for reception and returns/sending of on-line purchases and/or hire services using the cabinets as logistics interchange points.

The system automatically determines and selects a suitable cabinet, sufficiently large to contain an item, based on the information gathered from the shipper through a proprietary application that evaluates the dimensions of the item and selects the appropriate cabinet size based on these parameters within the chosen and available cabinet array.

Each cabinet is connectively networked within the array and the array itself is networked to throughout the entire platform, connected via Internet. Each cabinet array has an intelligent terminal consisting of a CPU (Central Processing Unit), a user interface monitor, which may work simultaneously as an input device, alternative input devices, such as keyboards and voice recognition software, through which users interact with a specific cabinet on the array, to assign a use such as receive, send, share, exchange or store. A central server administers and manages the platform's general database.

User notifications, primarily access codes and transaction completion notices, are generated and sent via electronic mail, and/or text messaging, to the user, whether commercial courier or individual, reflecting all events transacted. Every transaction of every cabinet in every array is recorded on the central server to provide traceability and auditability. The central server manages every user, or group of users, logged on. Users access the central server using any internet-connected device, through a username and a password, or other token security protocol. Passwords may be stored in encrypted form using asymmetric encryption algorithm MD5.

After registration, depending on a user's profile, a user may, using its password, access and use any public or private cabinet array and manage its account via the web. A user may purchase credits, be grouped with other users, access its transaction history, including pending transactions, manage permissions so third parties may access a designated cabinet for exchange of items, book a cabinet in a chosen array, authorize third party users, such as a courier, supplier, or a concierge, request or authorize membership of a private cabinet array, and share a cabinet with other users. These are some examples of the possible transactions that may be managed through the web.

### BRIEF DESCRIPTION OF THE DRAWINGS

FIG. 1 is a view of an embodiment of invention depicting a Central Server Computer and a plurality of cabinet arrays.

FIG. 2 is a detailed view of an embodiment of a cabinet array.

FIG. 3 is a detailed view of an embodiment of a cabinet array computer user interface page.

FIG. 4 is a detailed view of an embodiment of a lockable cabinet depicting its locks and monitoring equipment.

### DETAILED DESCRIPTION OF THE INVENTION

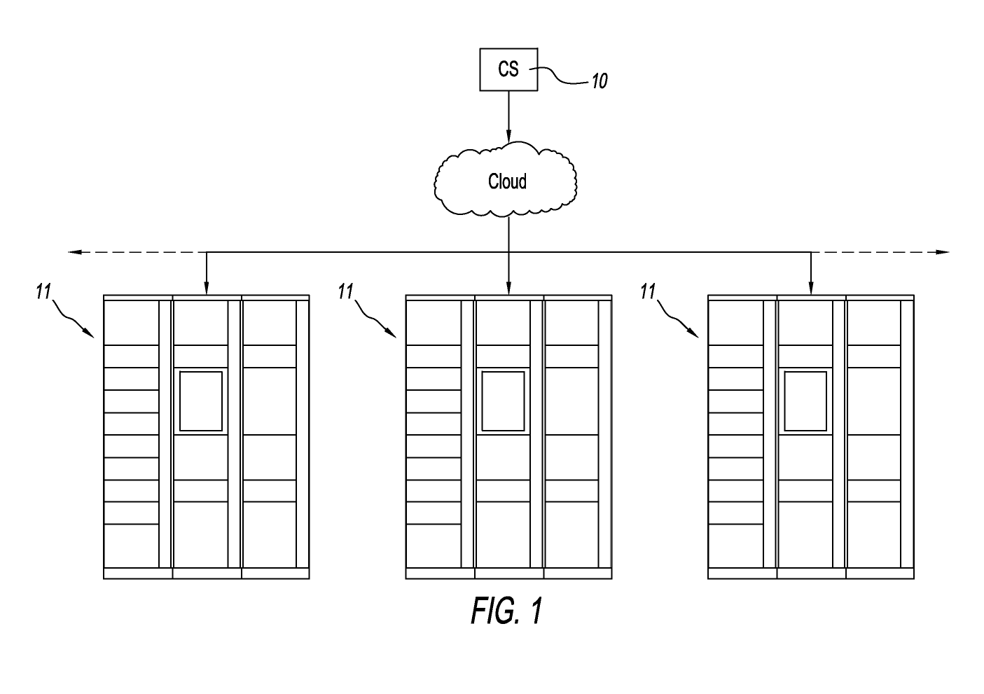

FIG. 1 shows an overall view of an embodiment of the invention. A central server computer (10) connects through a variety of communication means, such as for example and without limitation, wired, wireless, cloud, cellular, satellite, and others well known to persons skilled in the art, with a plurality of cabinet arrays (11) located in diverse and remote locations.

The central server computer (10) hosts at least one database containing user information and the operations associated with each of them, whether individuals, groups, or companies. The computer (10) manages registered users and their unique codes, i.e., provides two-way operation. The computer also grants, at the request of registered users, cabinet access rights to not-registered third parties, and conversely permits non-registered third parties to access a cabinet to deliver an item for a registered user.

The central server computer (10) manages the overall functionality of the platform, registers and administers users rights and privileges, grants cabinet access rights to not-registered third party users, such a commercial logistics companies, keeps a database of all transactions involving users and cabinets, troubleshoots problems at remote cabinet arrays, synchronizes its database with the remote cabinet array computers database, provides notifications of transactions to the relevant users and not-registered third parties, provides an auditable trail for any and all transactions on real time and historically, and guarantees overall functionality to all aspects of the inventive platform.

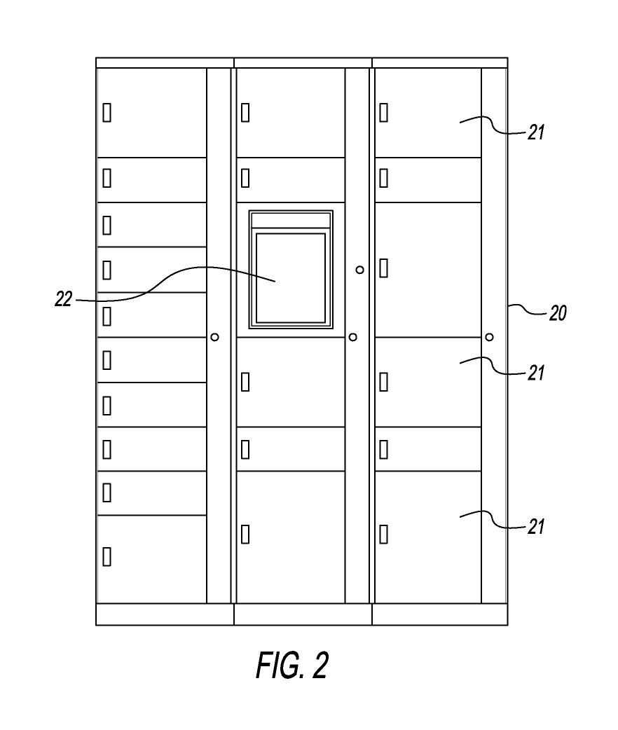

FIG. 2 shows an embodiment of a cabinet array of the novel logistics platform that is comprised of multiple lockers of various sizes, such that items of different sizes are matched to a specific cabinet capacity to maximize the efficient utilization of cabinet space.

Each cabinet array (20) contains a plurality of lockable cabinets (21), each containing an electronic opening means, such as, for example and without limitation, solenoid actuated locks, electro-mechanical locks, and electro-magnetic locks, all well known to a person skilled in the arts.

Cabinet arrays (20) may have a modular design built on a number of columns, containing a plurality of lockable cabinets (21) of the same or varied sizes that result in a more appropriate setting for each logistic demand such as delivery, removal, storing, and or exchanges.

A cabinet array computer (22) controls and actuates each cabinet's locks and its monitoring and verification devices. The computer (22) also keeps an independent database that contains a list of all users and third party users with privileges cabinet access, and all transactions occurring within a cabinet and within the plurality of cabinets constituting the array. The computer (22) also manages the cabinet's verification sensors, audiovisual equipment devices, and generally governs access to each cabinet. The cabinet array computer (22) connects via a plurality of means, including but not limited to Internet, cellular, WIMAX, wired and wireless means well known to a person skilled in the art, to a central server computer and synchronizes its database such that all records are kept current and it functions as a back-up in the event of cabinet array computer (22) failure.

The cabinet array computer (22) hosts proprietary software and a local database, which is automatically synchronized with the central server (10) via known communications means, including the Internet. All local operations are independent from the central server (10) and are supported by an independent power supply and a back-up power supply, thus ensuring the array's uninterrupted functionality.

The proprietary software has three configurations: Corporate, Front Desk, and Pick-Up. In the Corporate and Front Desk configurations, users must be registered in order to use the personalized system. These configurations also include the possibility of forming groups of users for one or more cabinet arrays, as groups or families. In the Pick-Up configuration, users use unique codes for each cabinet access (item delivery or retrieval). The software on the Pick-Up configuration allows a user to configure the appearance of the system at the cabinet array level to the needs of each operator using it and works with unique codes for each access.

Each cabinet array database is synchronized by exchanging information with the central server (10). This exchanged information contains data created by the cabinet's operations, including but not limited to, access codes, sender and recipient identification, type of operator, cabinet size, status of the transaction, current state of the cabinet, user's data, operators, cabinet array information, individual cabinet status and information (free, occupied, cabinet functionality problems), and system status.

The cabinet array local operations do not require access to the communications network, Internet, or the central server, to operate. The system provides for all operations to be completed without an external connection.

Users can access the logistics platform by way of any Internet connected device through a proprietary application-programming-interface, which provides full access and functionality.

The central server (10) may be accessed externally through a website. This website also provides a billing system that manages all operations related to payment /recovery operations. A website user may manage its account's status, view each transaction costs, account balance, and credits. In addition, users may view their transactions type, and a complete history of their previous transactions. A user may also, create an access code for a non-registered user to deposit or retrieve an item from a cabinet. Furthermore, users may view, associate, or disassociate from groups or families; view and manage all the cabinets associated with the user, current and historical; access the Pick-Up configuration that allows a registered user to use the platform for item retrieval by a non-registered user. Registered users can view their Pick-Up transactions, create, delete, manage, view statistics of their transactions, and view the status of individual cabinets or cabinet arrays.

In the Corporate or Front Desk configurations, the logistics platform may be expected to create any number of groups, open or closed, to use some or all of the platform functionalities, i.e. delivery, retrieval, storage, exchange, and/or sharing.

The platform allows any person, whether registered or not, to make a delivery. The platform only requires one of the parties involved in the transaction to be on the record. A user who is registered can deliver, or allow for retrieval, to one that is not, the platform generates a unique code for the recipient to access a cabinet.

A unregistered user, such as a commercial courier, can deliver to a registered user, so long as the registered user is the recipient. In this case, the recipient will be notified by the platform of the arrival of an item and may be thereafter withdraw it by entering the user code using the alternate opening.

A registered user may use all the functionalities of the platform and allow others to do the same by providing a plurality of access codes, one for each authorized transaction at a particular cabinet. The platform will notify the user via email and/or text message, for each transaction occurred, allowing for control or audit the cabinet.

A registered user may be associated with one or more cabinet arrays.

Users functioning as suppliers may use the cabinet arrays as logistic delivery and retrieval points.

A single administrator may manage, monitor, and audit, one or more cabinet arrays.

In the Pick-Up configuration the platform may host a single individual network, open or closed, to make deliveries and retrieval of items. The platform enables anyone with a hosted mobile application to make a delivery to a lockable cabinet. A closed individual network involves only members registered in a group, while and open group accepts unregistered users.

The platform further allows companies or logistics operators, who join one or more groups, to utilize some or all the cabinet arrays.

The platform generates a unique code for each cabinet access. The single generation code allows for auditing and control of every transaction occurring at each cabinet.

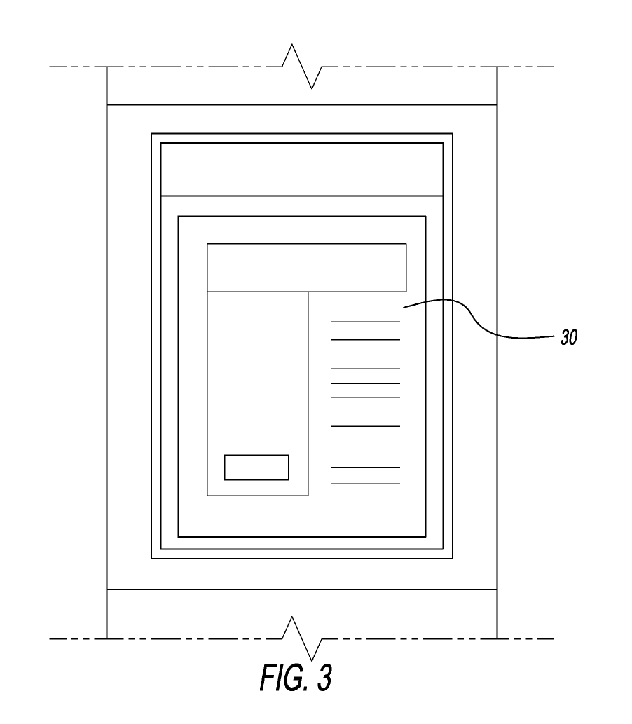

FIG. 3 depicts a user interface page (30) on the cabinet array computer. Users can register remotely with the platform utilizing any internet accessible device, but they can also register at the cabinet array computer. Cabinet operations are performed by registered users accessing the platform via username, password or token, and/or alternative opening codes. In some cases, cabinet operations may be accessed by non-registered users, such as a commercial courier retrieving or depositing an item, or an occasional individual who needs access on a need to access basis, who have been provided with an access code by a registered user.

The user interface page (30) depicts the platform options that may be used and configured by any user to deliver, remove, store, share, or exchange

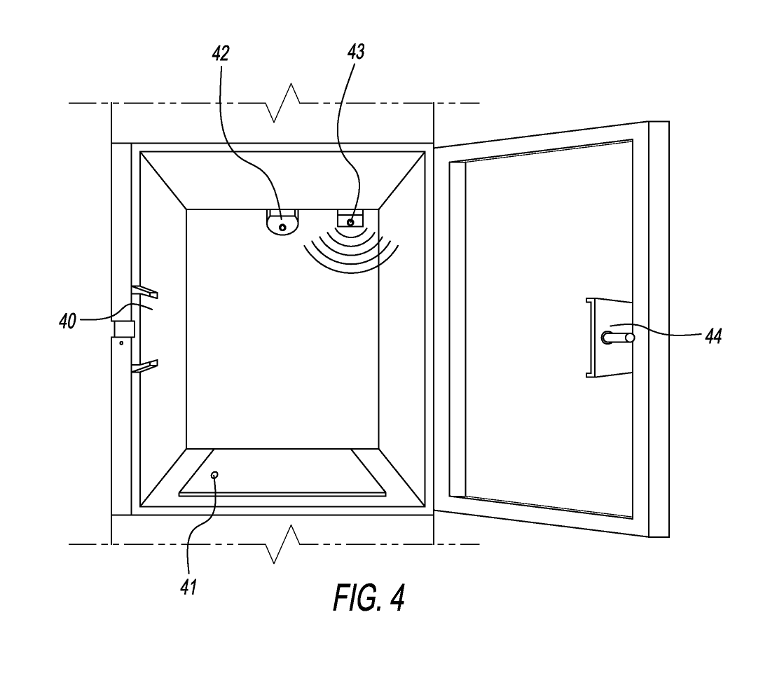

FIG. 4 depicts some of the verification equipment that may be used to ensure transaction completeness and traceability. A lockable cabinet (40) may use a weight sensor device (41), such as a strain gauge or others well known by those skilled in the art, to determine if anything has been placed in the cabinet. An audiovisual device (42), such as a video camera, may be used to snap a photograph or capture video of a cabinet transaction, to provide further evidence that the transaction has been performed as intended and no fraudulent actions had taken place. An unfilled sensor device (43) may be also used to corroborate that a cabinet is completely, and not partially, emptied of its contents, before it is locked (44) by a user or an unregistered third party.

The novel platform does not require intermediate operators to administer and use the system. Users can deliver, remove, store, share and exchange objects without involving third parties.

A cabinet array, such as those functioning as a private cabinet, may be serviced by a concierge facilitator, but there is no requirement that such third party be necessary for the full and complete operation of the system.

The platform, and each or its individual cabinets and components, may be remotely accessed by a platform administrator with full access to troubleshooting diagnostics and repairs, software updates, and complete auditing.

1. A logistics platform to facilitate deposit, retrieval, sharing, exchange, and storage of an item, the logistics platform comprising:
at least one cabinet array comprising of at least two lockable cabinets;
a cabinet array computer, disposed in the at least one cabinet array, communicatively connected to each of the at least two lockable cabinets, capable of selectively permitting independent access to one of the at least two lockable cabinets, capable of monitoring the contents or lack thereof of each of the at least two lockable cabinets, capable of selecting one from at least two lockable cabinets according with an item's dimensions suitability, managing a plurality of users and the at least two lockable cabinet usage database, interfacing with a user through an audiovisual input device, selecting one from the at least two lockable cabinets, and generating an individual transaction code for each access to each of the at least two lockable cabinets;
a central server computer, communicatively connected to the cabinet array computer, capable of managing a plurality of users and the at least two lockable cabinet usage database, synchronizing its database with the database of the cabinet array computer, communicatively connected to other third party computers, generating an individual transaction code for each access to one of the at least two lockable cabinets and transmitting the individual transaction code to a user to permit its access to the one of at least two lockable cabinets; and
a power supply, to furnish continuous uninterrupted power to the cabinet array computer, the central server computer, and to each lockable cabinet.

2. The logistics platform of claim 1, wherein one of the at least two lockable cabinets is of different internal dimensions from the other.

3. The logistics platform of claim 1, wherein the independent access to one, of the at least two, lockable cabinets represents one transaction selected from a group consisting of depositing, retrieving, sharing, exchanging, and storing an item.

4. The logistics platform of claim 1, wherein the monitoring the contents or lack thereof of each of the at least two lockable cabinets is performed by at least one sensor selected from a group consisting of a video capture device, an audio capture device, an unfilled sensor device, and a weight sensor device.

5. The logistics platform of claim 1, wherein the selection of one, from at least two, lockable cabinets according with an item's dimensions suitability is performed by at least one selected from a group consisting of a user and an application programming interface tailored and coupled to a third party vending website.

6. The logistics platform of claim 1, wherein the interface with a user through an audiovisual input device is performed by at least one selected from a group consisting of a touch screen device, a keystroke input device, and a voice recognition input device.

7. The logistics platform of claim 1, wherein the managing a plurality of users database requires a user to be registered and to secure a password or a token.

8. The logistics platform of claim 1, wherein the transmitting the individual transaction code to an unregistered third party to permit access to the one of at least two lockable cabinets further comprises the step of transmitting at least one electronic mail or text message notification selected from a group consisting of an item has been delivered to the cabinet and an item has been removed from the cabinet.

9. The logistics platform of claim 1, wherein the lock of each of the at least two lockable cabinets is selected from a group consisting of an electromechanical lock, an electronic lock, and digital lock.

10. The logistics platform of claim 1, wherein the power supply is a battery backed up uninterrupted power supply.

11. A logistics platform method to facilitate deposit, retrieval, sharing, exchange, and storage of an item, the method comprising:
registering a user;
accessing one computer, from a group selected from a cabinet array computer and a central server computer, by the user;
selecting one transaction, from a group consisting of depositing, retrieving, sharing, exchanging, and storing an item, by the user;
selecting one, from at least two, lockable cabinets from at least one cabinet array, by the user or by the one accessed computer;
obtaining from the one accessed computer an access code to the selected lockable cabinet for the selected transaction;
accessing the selected lockable cabinet;
depositing or retrieving an item from the selected lockable cabinet;
verifying, through monitoring sensors, the selected transaction performed, whether the accessed lockable cabinet condition changed from empty to item occupied, from item occupied to empty, from empty to empty, from item occupied to same item occupied, or from item occupied to new item occupied;
closing and locking the selected lockable cabinet;
generating a message notifying the user that the lockable cabinet was accessed and its current condition; and
updating a user and cabinet usage database hosted on the cabinet array computer and synchronizing it with the central server computer about the transaction occurred and the lockable cabinet current condition.

12. The logistics platform method of claim 11, wherein the monitoring the contents or lack thereof of each of the at least two lockable cabinets is performed by at least one sensor selected from a group consisting of a video capture device, an audio capture device, an unfilled sensor device, and a weight sensor device.

13. The logistics platform method of claim 11, wherein the transaction of sharing an item further comprises the steps of:
selecting a first user and at least a second user;
selecting one from the at least two lockable cabinets from the at least one cabinet array, such that the selected lockable cabinet has suitable dimensions to accommodate an item selected by the first user;
generating unique access codes, for the first user and for the at least second user, by the one accessed computer, and subsequently for each access to the selected lockable cabinet by any user;
accessing the selected lockable cabinet and depositing or retrieving an item by the first user or by the at least second user;
verifying, through monitoring sensors, the selected transaction performed, whether the accessed lockable cabinet changed its condition from empty to item occupied, from item occupied to empty, from empty to empty, from item occupied to same item occupied, or from item occupied to new item occupied;
closing and locking the selected lockable cabinet;
updating the cabinet array computer user and cabinet usage database;
synchronizing the cabinet array computer database with the central server computer database; and
notifying the first user and the at least second user of who last accessed the cabinet and whether there is an item in the lockable cabinet.

14. The logistics platform method of claim 11, wherein the transaction of retrieving an item is carried out by a third party user and further comprises the steps of:
selecting a third party user retrieving transaction by a user;
selecting one from the at least two lockable cabinets from the at least one cabinet array by the user such that the lockable cabinet has suitable dimensions to accommodate an item;
generating a user access code for the selected lockable cabinet, by the one accessed computer;
accessing the selected lockable cabinet and depositing an item, by the user;
generating an access code for a third party user, by the one accessed computer;
notifying the third party user about the location of and access code to the selected lockable cabinet, by the one accessed computer;
retrieving the item from the selected lockable cabinet and closing the lockable cabinet by the third party user;
verifying, through monitoring sensors, the selected transaction performed, whether the accessed lockable cabinet changed its condition from empty to item occupied, from item occupied to empty, from empty to empty, from item occupied to same item occupied, or from item occupied to new item occupied;
notifying the user that the item was retrieved by the third party user, by the one accessed computer;
updating the cabinet array computer user and cabinet usage database; and
synchronizing the cabinet array computer database with the central server computer database.

15. The logistics platform method of claim 11, wherein the transaction of exchanging items further comprises the steps of
selecting a first user and a second user;
selecting one from the at least two lockable cabinets from the at least one cabinet array, such that the selected lockable cabinet has suitable dimensions to accommodate an item selected by the first user;
generating unique access codes, for the first user and for the second user, by the one accessed computer for the selected lockable cabinet;
accessing the selected lockable cabinet and depositing an item by the first user;
verifying, through monitoring sensors, the selected transaction performed, whether the accessed lockable cabinet changed its condition from empty to item occupied, from item occupied to empty, from empty to empty, from item occupied to same item occupied, or from item occupied to new item occupied;
closing and locking the selected lockable cabinet, by the first user;
updating the cabinet array computer user and cabinet usage database;
synchronizing the cabinet array computer database with the central server computer database;
notifying the first user of the transaction and the second user that an item has been deposited in the lockable cabinet;
accessing the selected lockable cabinet and retrieving the item by the second user;
verifying, through monitoring sensors, the selected transaction performed, whether the accessed lockable cabinet changed its condition from empty to item occupied, from item occupied to empty, from empty to empty, from item occupied to same item occupied, or from item occupied to new item occupied;
closing and locking the selected lockable cabinet, by the second user;
updating the cabinet array computer user and cabinet usage database;
synchronizing the cabinet array computer database with the central server computer database; and
notifying the second user of the transaction and the first user that the exchange transaction has been completed.

16. The logistics platform method of claim 11, further comprising the step of receiving payment for at least one transaction.
